(19) United States
(12) Patent Application Publication
(10) Pub. No.: US 2017/0341114 A1
(43) Pub. Date: Nov. 30, 2017

(54) APPARATUS FOR CLEANING OF CONVEYING UNITS FOR MEDIA CAPABLE OF FLOW

(71) Applicant: Lutz Pumpen GmbH, Wertheim (DE)

(72) Inventor: Heinz LUTZ, Wertheim (DE)

(73) Assignee: Lutz Pumpen GmbH, Wertheim (DE)

(21) Appl. No.: 15/597,284

(22) Filed: May 17, 2017

(30) Foreign Application Priority Data
May 24, 2016 (DE) 10 2016 109 504.4

(51) Int. Cl. B08B 9/032; B08B 9/023

(52) U.S. Cl. CPC B08B 9/0321; B08B 9/023

(57) ABSTRACT

Many conveying units for media capable of flow are used for products that are harmful to the environment and at least attack the conveying units themselves over time or deposit in them and clog them. Cleaning of the conveying units is therefore recommended, but such cleaning represents an effort that is preferably not made, because of the effort involved. Against this background, an apparatus for cleaning of conveying units, which apparatus can run both in simple manner and practically without supervision, uses a cleaning circuit in which the conveying unit to be cleaned is short-circuited with a cleaning agent tank and thereby constant circulation of cleaning agent through the conveying unit to be cleaned is pumped and the unit is thereby cleaned.

### CROSS REFERENCE TO RELATED APPLICATIONS

Applicant claims priority under 35 U.S.C. §119 of German Application No. 10 2016 109 504.4 filed May 24, 2016, the disclosure of which is incorporated by reference.

### BACKGROUND OF THE INVENTION

### 1. Field of the Invention

The present invention relates to an apparatus for cleaning of conveying units for media capable of flow. The apparatus forms a cleaning circuit in terms of flow technology, in which a cleaning agent passes through a cleaning agent tank and at least one conveying unit to be cleaned, one after the other. At least one of the conveying units to be cleaned circulates the cleaning agent in the cleaning circuit.

### 2. Description of the Related Art

Such a solution is already previously known from DE 197 41 242 C1. There, a system for cleaning a filling system is described, as it is used, for example, in gastronomy. This solution provides for conveying a cleaning agent out of a cleaning agent tank instead of the beverages that are otherwise conveyed, and for draining it by way of the dispensing system. Cleaning of the filling system takes place in this way.

Conveying units are used in numerous sectors of commerce and industry. Fundamentally, practically any liquids, having the most varied viscosities, which are to be transferred from one container to another, can be conveyed using them. For example, conveying units can be equipped with pump lances and thereby project into a barrel, wherein the conveying unit extracts the liquid contained in the barrel by way of the pump lance and conveys it further.

Frequently, conveying units are used in industry for different media, so that it is necessary to return the conveying units for internal and external cleaning in order to completely remove a medium that was conveyed first, before a conveying unit is used for conveying a second medium. Only in this way can it be guaranteed that contamination of the conveyed media is effectively prevented.

In general, however, careful cleaning of a conveying unit, particularly also of a pump lance, represents a complicated work step that is frequently forgotten or skipped by user personnel. Aside from contamination of the media to be conveyed, soiling of the conveying units and, over time, damage to them also comes about in this regard, and correction of these problems then becomes even more complicated and cost-intensive and furthermore causes extended downtime of the conveying unit.

### SUMMARY OF THE INVENTION

Against this background, it is an object of the present invention to provide an apparatus for cleaning of conveying units for media capable of flow, which apparatus can be used in very simple and effective manner, in order to keep the efforts on the part of the users connected with this effort as low as possible.

These and other objects are accomplished by means of an apparatus for cleaning of conveying units for media capable of flow, in accordance with the invention. Further practical embodiments of such an apparatus are discussed below.

According to the invention, it is provided that an apparatus for cleaning of conveying units for media capable of flow first of all forms a cleaning circuit in terms of flow technology, in which a cleaning agent is pumped in circulation between a cleaning agent tank and the conveying unit to be cleaned. The cleaning agent is also a medium capable of flow, which gets everywhere that the media capable of flow that are conveyed during operation of the conveying unit also get to, because it passes through the conveying unit. In a simple case, the cleaning agent can simply be water, but active substances such as soaps or other chemical, disinfectant or solvent-containing substances can also be mixed into the water. Also, other cleaning agents on the basis of hydrocarbons, such as alcohols, benzenes and the like can be used or can form the basis for a cleaning agent.

First of all, the cleaning agent tank is filled with the cleaning agent in this regard. Then, circulation in the cleaning circuit that has been formed in this manner is started. In this regard, circulation takes place using the actual conveying unit to be cleaned, which unit conveys the cleaning agent coming from the cleaning agent tank through itself and conducts it back into the cleaning agent tank.

In this way, the possibility is created for the user of cleaning the conveying unit in that it is simply mounted into the cleaning circuit described and then operated. Supplementally, after a flushing process, the cleaning agent can still be replaced with an agent for rinsing, which also rinses the substances of the cleaning agent away to a great extent. Also, it is possible to allow the conveying unit to stand with the cleaning agent in it overnight, for example, between the flushing step and the rinsing step, so that the substances of the cleaning agent can act. Also, the pump can be allowed to stand in the flushing step overnight, in order to remove even intensive soiling.

In every case, complicated cleaning steps for cleaning the conveying apparatuses are eliminated in this way, so that careful cleaning becomes more attractive and simpler for the user, as well as more effective.

The structure of such a cleaning circuit depends on the conveying units to be cleaned, to some extent. A metering pump, for example, has a feed and a drain, which can be directly connected with the cleaning agent tank, so that the metering pump, as the conveying unit, conveys directly out of the cleaning agent tank into the cleaning agent tank. The feed is then connected with a drain of the cleaning agent tank by way of a feed line, and the drain is connected with a feed of the cleaning agent tank by way of a drain line.

If, in contrast, the conveying unit is a container pump having a pump lance, the apparatus must look somewhat different. Here, one possibility already exists in introducing the pump lance directly into the cleaning agent tank and structuring the cleaning agent tank as an immersion container for this purpose. Then the container pump will convey cleaning agent out of the immersion container and return it directly to the container by way of a feed.

Furthermore, the immersion container provided for cleaning of the container pump can be configured separately from the cleaning agent tank. Then, the cleaning circuit provides an immersion container having a top introduction opening for introduction of the pump lance of the container pump. The container pump then draws the cleaning agent out of the immersion container and conveys it back into the cleaning agent tank, from where it can flow back into the immersion container by way of a feed line.

To some advantage, the immersion container can have a narrowed section in its upper region, in other words around the introduction opening, so that the pumping effect becomes stronger in the upper region and there the flow caused by the pump flows more quickly. This arrangement additionally improves the cleaning effect.

The immersion container can furthermore have an introduction funnel at its top introduction opening, which funnel widens upward, and by way of which positioning of the pump lance of a container pump to be connected with the immersion container is simplified. Furthermore, such an introduction funnel can possibly catch medium that drips off the conveying unit and allow it to run into the immersion container, so that no contaminations occur around the apparatus.

Furthermore, a drip protection plate can be affixed on this introduction funnel, which plate is structured in the form of a gutter, for example, and can be releasably connected with the top edge of the introduction funnel by means of clamping, insertion, screw connection and the like. The introduction funnel brings about rather local drip protection; however, the drip protection plate can cover the entire path out of a container to the immersion container, and catch possibly falling droplets and guide them into the introduction funnel. For this purpose, it is true that the drip protection plate can be laid onto the introduction funnel and the container in which the container pump was previously operated, but in order to guarantee that the dripping liquid runs into the introduction funnel, the drip protection plate must be at least horizontal, preferably inclined downward at an angle between 0° and 10° relative to the top edge of the introduction funnel, and particularly preferably should project from this top edge, in self-supporting manner.

After introduction of the pump lance with the container pump attached to it into the immersion container, the container pump is turned on for cleaning. As a result, vibrations can occur, which cause noise and insecure mounting of the container pump in the immersion container. For this reason, a fixation device can be provided in the region of the introduction opening of the immersion container, with which device the pump lance and thereby the container pump connected with the pump lance are fixed in place relative to the immersion container.

Such a fixation device can be formed by a plurality of clamping screws distributed over the circumference of the outer wall of the immersion container. These screws can be screwed through the outer wall using a thread cut into the outer wall or set in front of it, toward the center of the introduction opening. They then meet the pump lance and fix it in place from several sides, until the pump lance is held in immovable manner. The clamping screws can be provided with end-position hand wheels, in order to be able to perform fixation simply by hand, in other words without tools.

An essential aspect of the invention is cleaning of conveying units from the inside, in that the cleaning agent is pumped through the conveying units. Particularly in the case of the aforementioned container pumps, however, external cleaning, particularly in the region of their pump lance, is practical, because this lance projects into the medium to be conveyed also with its outside during operation, at least in part. In order to bring about external cleaning, the outer wall of the immersion container can have a plurality of feed lines assigned to it, preferably in the region of the introduction opening, by way of which lines cleaning agent is introduced, advantageously sprayed into the immersion container from the immersion container or from the cleaning agent tank. During the moment of immersion of the pump lance, the pump lance is sprayed during this process, and thereby freed of dirt externally while it is being introduced into the immersion container.

In a concrete embodiment, a cuff chamber can be formed around the introduction opening, on the inner wall of which one or more feed openings, preferably uniformly distributed over the inside circumference of the inner wall of the cuff chamber, face in the direction of the pump lance. By means of pressure application to the cuff chamber, the cleaning agent can reduce the pressure by way of the feed openings, by way of which the cleaning agent is injected into the interior of the pipe.

Furthermore, it can be practical to assign an auxiliary pump to the feed line that is connected with the cuff chamber, because otherwise, the container pump cannot yet circulate any cleaning agent at the first moment of its introduction. If necessary, the auxiliary pump can support the conveying unit to be cleaned or only work alternately with it.

In the bottom region, the feed line or, alternatively or additionally, the drain line has a bottom drain that is preferably formed at a geodetically lowest point and allows emptying of the cleaning circuit on the basis of gravity. In this regard, a drain valve prevents unintentional loss of cleaning agent and can therefore switch back and forth between an open and a closed position.

Supplementally, a filter arrangement can be assigned to the bottom drain; this filter arrangement can be used to separate and/or neutralize substances of the cleaning agent. In this way, harmful substances contained in the cleaning agent are prevented from exiting and representing an environmental toxin.

Furthermore, a heating element can be assigned to the cleaning circuit. Using such a heating element, which can be structured as a flow-through heater or the like, for example, the temperature of the cleaning agent can be increased in order to also use thermal reaction forces for a better cleaning effect.

During operation, the cleaning agent is continuously pumped in circulation, so that approximately no change in the amount of cleaning agent takes place during a cleaning process. For first filling, however, the cleaning agent tank or, if applicable, the immersion container can have a filling opening at which a filling line can be connected with a cleaning agent source such as a water line or a cleaning agent container, for example. In this regard, active cleaning additives can be metered into the cleaning agent, preferably in addition, for example using a metering pump, preferably a proportional metering unit, assigned to the filling line.

The entire cleaning circuit functions with a single conveying unit, in its simplest arrangement, at first. It is also possible, however, to connect multiple conveying units one behind the other, in terms of flow technology, so that the cleaning agent flows through the individual conveying units one after the other. In this case, however, only one of the conveying units should be actively operated. The other conveying units are at most driven by the flowing cleaning agent. If multiple conveying units were operated at the same time, pressure could build up between multiple conveying units having different conveying output, and this pressure could damage the conveying units.

Finally, it represents a particularly preferred embodiment if the cleaning circuit with its elements is disposed on a transport vehicle, such as a hand cart, as a mobile construction. Thus, the apparatus according to the invention can always be brought to the location where the conveying units are to be cleaned, and it is not necessary to bring the conveying units, which can sometimes be very soiled, to a specific location, thereby also soiling the surroundings or having to expend great effort for packaging or even pre-cleaning.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a schematic cross-sectional representation from the side of an apparatus for cleaning of conveying units for media capable of flow;

FIG. 2 is a schematic cross-sectional representation from the side of a detail of the apparatus according to FIG. 1; and

FIG. 3 is a fundamental block schematic of a cleaning circuit.

### DETAILED DESCRIPTION OF PREFERRED EMBODIMENTS

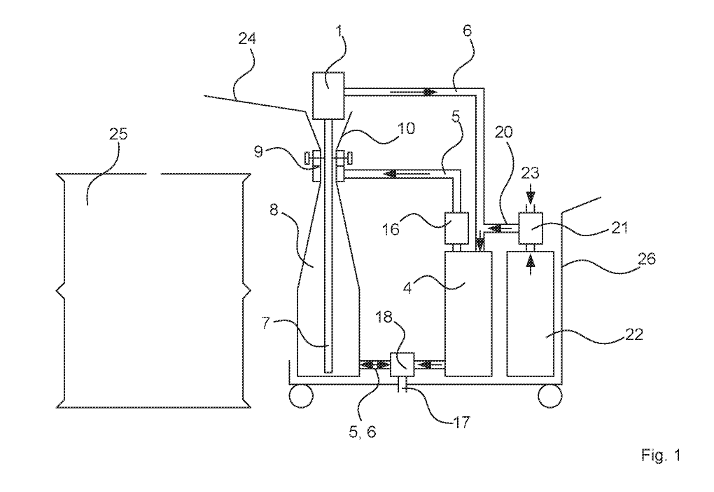

FIG. 1 shows a hand cart 26 that is mounted on wheels and is thereby equipped to be mobile. This hand cart 26 is set up in the immediate vicinity of a barrel 25, from which a conveying unit 1 having a pump lance 7 has just been removed and pushed into an immersion container 8. The conveying unit 1 was previously used in the barrel 25 as a container pump, in order to convey the content of the barrel 25 out and pass it along to its destination. Now that the conveying unit 1 is no longer needed in the barrel 25, the conveying unit 1 with its pump lance 7 is pulled out of the barrel 25 and introduced into the immersion container 8 for cleaning.

In order to make it easier to introduce the pump lance 7 of the conveying unit 1 into the immersion container 8, the immersion container 8 has an introduction funnel 10. A drip protection plate 24 is releasably attached to this introduction funnel 10, at the edge of the introduction funnel, so that the pump lance 7 does not leave any contaminants when it is pulled out of the barrel 25 and placed into the immersion container 8. The pump lance 7 is always situated above the barrel 25, the drip protection plate 24, configured as a gutter, or the introduction funnel 10, until it has been introduced into the interior of the immersion container 8 through an introduction opening 9 in the center of the introduction funnel 10.

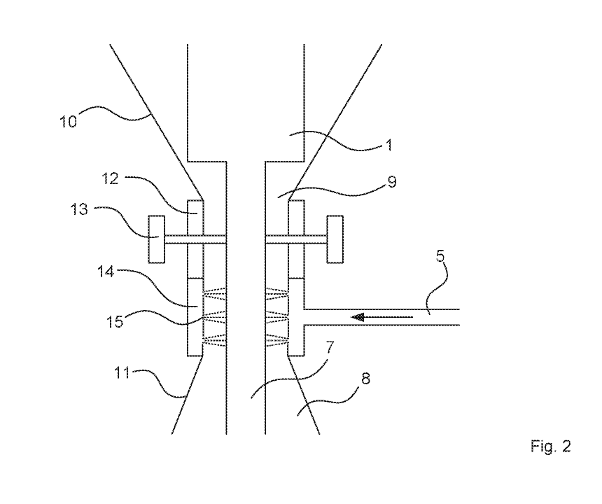

Also disposed on the hand cart is a cleaning agent tank 4, which sprays cleaning agent onto the pump lance by way of an auxiliary pump 16, through a cuff ring 14 of the immersion container 8, as will be described below with regard to FIG. 2. Also, the cleaning agent tank 4 is connected with the immersion container 8 by way of a feed/drain line 5, 6 close to the floor/ground, and with a drain of the conveying unit 1 by way of a drain line 6. The cleaning agent kept on hand in the cleaning agent tank 4 is then introduced into the immersion container 8, during ongoing operation of the arrangement as described, from the cleaning agent tank 4, by way of the feed lines 5, and there cleans the pump lance 7 from the outside. The conveying unit 1 is operated for this purpose, so that cleaning agent contained in the immersion container 8, for example water with a cleaning additive, is drawn in at the free end of the pump lance 7 and pumped back into the cleaning agent tank, through the pump lance 7 and the conveying unit 1 itself. Cleaning of the conveying unit 1 from the inside and from the outside takes place because of the flow through the conveying unit 1 and the flow around the immersed parts.

For first filling of the cleaning circuit, an additive tank 22 is furthermore disposed on the hand cart 26, in which the cleaning additive is kept on hand. A proportional metering unit 21, which is also connected with a cleaning agent source 23, for example a water line or a further tank, is connected with this tank. The proportional metering unit ensures that a precise mixture of the desired cleaning agent is available and also, in the case of pure refilling, that the ratio between cleaning agent and cleaning additive remains the same.

To empty the cleaning circuit, a bottom drain 17 is provided, which is disposed in a feed/drain pipe close to the floor/ground between the cleaning agent tank 4 and the immersion container 8. By opening the drain valve 18, complete emptying of both the cleaning agent tank 4 and the immersion container 8 using gravity can take place; depending on the application case, the last medium conveyed, and the cleaning agent and cleaning additives used, this emptying can take place into a collection container or into the sewer system.

FIG. 2 shows the region of the introduction opening 9 of the immersion container 8 as a detail of FIG. 1. The immersion container 8 may have a narrowing 11 in its upper region, in other words around the introduction opening 8, so that the pumping effect becomes stronger in the upper region and there the flow caused by the pump flows more quickly. A cuff ring 14 that surrounds the introduction opening 8 is assigned to this immersion container 8. Using an auxiliary pump 16, cleaning agent is conveyed out of the cleaning agent tank 4 during introduction of the pump lance 7 of the conveying unit to be cleaned into the immersion container 8; this cleaning agent first fills a cavity in the cuff ring 14 and then sprays onto the pump lance 7 by way of feed openings 15 on the inside of the cuff ring 14. As a result, external cleaning of the pump lance 7 already takes place during its introduction into the immersion container 8, before internal cleaning is also added by means of startup of the conveying unit 1. The pump lance is clamped in place using clamping screws 13, which are disposed on a fixation device 12 and distributed over the circumference of the neck of the immersion container, so that during operation of the conveying unit 1, it does not vibrate to produce strong movements, but rather is securely held.

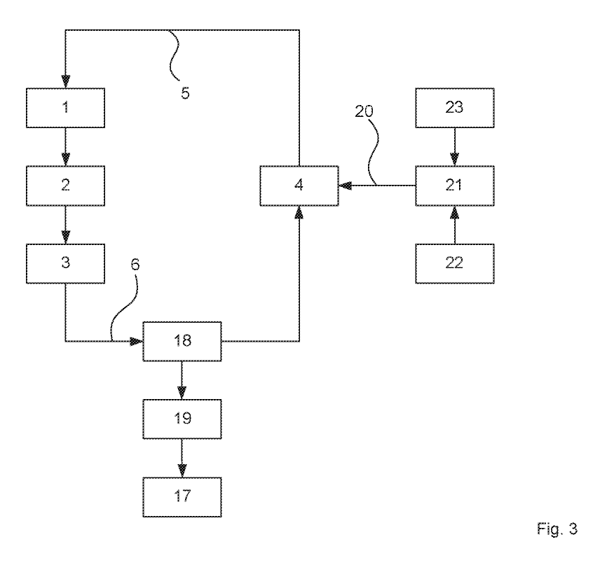

FIG. 3, finally, shows a schematic arrangement of the elements of the cleaning circuit for the case of simultaneous cleaning of three conveying units 1, 2, and 3 to be cleaned at the same time. These conveying units are placed in series, one behind the other, in terms of flow, so that cleaning agent that is brought in from a cleaning agent tank 4 by way of a feed line 5 first passes through the conveying unit 1, then the conveying unit 2, and finally the conveying unit 3, before it is conveyed back to the cleaning agent tank 4 by way of a drain line 6. In this regard, only the first is an active conveying unit 1. The other two are passive conveying units 2 and 3, which are driven by the active conveying unit 1.

As has already been described with regard to first filling of the cleaning circuit, a proportional metering unit 21 is connected with the cleaning agent tank 4 by way of a filling line 20 and is supplied from a cleaning agent source 23 and an additive tank 22 with a cleaning additive. The components are mixed, and the cleaning agent tank 4 is filled with this mixture for the first time.

After use, the drain valve 18 is opened and the soiled cleaning agent is cleaned by way of a filter arrangement 19 and removed from the system by way of a bottom drain.

What is described above is therefore an apparatus for cleaning of conveying units for media capable of flow, which guarantees simple and effective cleaning by means of circulation of cleaning agents through one or more cleaning units.

Although only a few embodiments of the present invention have been shown and described, it is to be understood that many changes and modifications may be made thereunto without departing from the spirit and scope of the invention.

What is claimed is:

1. A cleaning apparatus comprising:
(a) at least one conveying unit for media capable of flow having a drain;
(b) a cleaning agent tank comprising an immersion container having a top introduction opening connected with the at least one conveying unit to be cleaned;
(c) a pump lance for introduction through the top introduction opening; and
(d) a drain line connecting the drain with a feed of the immersion container;
wherein a cleaning circuit is formed in terms of flow technology so that a cleaning agent passes through the cleaning agent tank and the at least one conveying unit to be cleaned and the at least one conveying unit circulates the cleaning agent in the cleaning circuit.

2. The apparatus according to claim 1, wherein the drain is connected with a feed line of the cleaning agent tank by way of the drain line, and wherein the feed of the immersion container is connected with a cleaning agent tank drain of the cleaning agent tank by way of a feed line.

3. The apparatus according to claim 2, wherein the immersion container narrows upward at least in one section.

4. The apparatus according to claim 2, further comprising an introduction funnel assigned to the immersion container at the top introduction opening, wherein the introduction funnel widens upward.

5. The apparatus according to claim 4, further comprising a drip protection plate is assigned to the introduction funnel.

6. The apparatus according to claim 5, wherein the drip protection plate comprises a gutter and is releasably connected with a top edge of the introduction funnel and projects away from the introduction funnel in self-supporting manner.

7. The apparatus according to claim 6, wherein the gutter is releasably connected with the top edge of the introduction funnel by an insertion connection or a clamping connection.

8. The apparatus according to claim 7, further comprising a fixation device assigned to the immersion container in a region of the introduction opening, for fixation of the pump lance with respect to the at least one conveying unit to be cleaned.

9. The apparatus according to claim 8, wherein the fixation device is formed from a plurality of clamping screws distributed over a circumference of an outer wall that encloses the introduction opening.

10. The apparatus according to claim 9, wherein the screws are provided with hand wheels.

11. The apparatus according to claim 9, wherein a plurality of feed openings distributed over the circumference of the outer wall that encloses the introduction opening are assigned to the immersion container in the region of the introduction opening, wherein the openings form or belong to the feed of the immersion container.

12. The apparatus according to claim 11, wherein the feed openings are formed in an inner wall of a cuff ring that runs around the circumference at least in certain sections where the cleaning agent is brought up from the cleaning agent tank by way of the feed line, and introduced into the immersion container by way of the feed openings.

13. The apparatus according to claim 12, wherein the cleaning agent is sprayed under pressure into the immersion container.

14. The apparatus according to claim 12, wherein the feed line to the cuff ring has an associated auxiliary pump, wherein the auxiliary pump conveys cleaning agent from the cleaning agent tank or the immersion container.

15. The apparatus according to claim 2, wherein at least one of the feed line and the drain line has an associated bottom drain for emptying via gravity the cleaning circuit by way of a drain valve.

16. The apparatus according to claim 15, further comprising a filter arrangement assigned to the bottom drain for at least one of separation and neutralization of harmful substances from the cleaning agent.

17. The apparatus according to claim 1, further comprising a heating element assigned to the cleaning circuit for tempering the cleaning agent.

18. The apparatus according to claim 17, wherein the heating element comprises a flow-through heater.

19. The apparatus according to claim 1, wherein the cleaning agent tank has a filling opening for connection with a cleaning agent source via a filling line for a first filling purpose, wherein active cleaning additives can be metered into the cleaning agent during the first filling using a metering pump comprising a proportional metering unit assigned to the filling line.

20. The apparatus according to claim 1, wherein the cleaning circuit comprises a plurality of conveying units placed one behind the other, in terms of flow technology, wherein only one of the conveying units is an active conveying unit used as a circulation pump and actively operated.
